(19) United States
(12) Patent Application Publication
(10) Pub. No.: US 2009/0113256 A1
(43) Pub. Date: Apr. 30, 2009

(54) Method, computer program product, apparatus and device providing scalable structured high throughput LDPC decoding

(75) Inventors: Predrag Radosavljevic, Houston, TX (US); Marjan Karkooti, Houston, TX (US); Alexandre de Baynast, Aachen (DE); Joseph R. Cavallaro, Pearland, TX (US)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/977,686

(22) Filed: Oct. 24, 2007

(51) Int. Cl. G06K 5/04

(52) U.S. Cl. 714/699

(57) ABSTRACT

The invention relates to low density parity check decoding. A method for decoding an encoded data block is described. Decoding is performed in a pipelined manner using a layered belief propagation technique and scalable resources, which are configurable to accommodate at least two codeword lengths and at least two code rates. A computer program product, apparatus and device are also described.

### TECHNICAL FIELD

The exemplary embodiments of this invention relate generally to wireless communication systems and, more specifically, relate to decoding of low density parity check codes in wireless communication systems.

### BACKGROUND

Certain abbreviations found in the description and/or in the figures are herewith defined as follows:
AN access node
APP a posteriori probability
ASIC application specific integrated circuit
BP belief propagation
DFU decoding function unit
DP data processor
DSPs digital signal processors
FEC forward error correction
FER frame error rate
FPGA field programmable gate array
LBP layered belief propagation
LDPC low density parity check
LLR log likelihood ratio
MEM memory
OFDM orthogonal frequency-division multiplexing
PCM parity check matrix
PROG program
RF radio frequency
RX receiver
SBP standard belief propagation
SNR signal to noise ratio
TRANS transceiver
TX transmitter
UE user equipment

In typical wireless communication systems hardware resources are limited (e.g., fully parallel architecture is not an acceptable solution because of the large area occupation on a chip, and small or no flexibility), therefore LBP decoding based on semi-parallel architecture may be applied. A major advantage of a LBP decoding algorithm in comparison with an SBP decoding algorithm is that the LBP decoding algorithm features a convergence that is approximately two times faster due to the optimized scheduling of reliability messages.

Decoding is performed in layers (e.g., set of independent rows of the PCM) where the APPs are improved from one layer to another. The decoding process in the next layer will start when APPs of the previous layer are updated.

See D. Hocevar, “A reduced complexity decoder architecture via layered decoding of LDPC codes,” in Signal Processing Systems SIPS 2004. IEEE Workshop on, pp. 107-112, October 2004; M. Mansour and N. Shanbhag, “High-throughput LDPC decoders,” Very Large Scale Integration (VLSI) Systems, IEEE Transactions on, vol. 11, pp. 976-996, December 2003; and P. Radosavljevic, A. de Baynast, and J. R. Cavallaro, “Optimized message passing schedules for LDPC decoding.” 39th Asilomar Conference on Signals, Systems and Computers, November 2005.

Current LDPC decoders must overcome the problems of supporting variable code rates and codeword lengths while achieving high decoding throughput with a reasonable degree of hardware parallelism.

In order to support the IEEE 802.11n wireless standard, LDPC decoders should achieve a decoding throughput of about 600 Mbits/sec while using limited hardware parallelism (e.g., a semi-parallel decoder). The decoder architecture should support decoding of a wide range of code rates and codeword sizes. Block structured parity check matrices with 24 sub-block columns are proposed in IEEE 802.11n standard and thus should also be supported.

### SUMMARY

An exemplary embodiment in accordance with this invention is a method for decoding an encoded data block. An encoded data block comprising codewords is stored. Decoding is performed in a pipelined manner using a layered belief propagation technique. Scalable resources, which are configurable to accommodate at least two codeword lengths and at least two code rates, are used for the decoding.

A further exemplary embodiment in accordance with this invention is a computer readable medium tangibly embodied with a program of machine-readable instructions executable by a digital processing apparatus to perform operations for decoding an encoded data block. An encoded data block comprising codewords is stored. Decoding is performed in a pipelined manner using a layered belief propagation technique. Scalable resources, which are configurable to accommodate at least two codeword lengths and at least two code rates, are used for the decoding.

Another exemplary embodiment accordance with this invention is an apparatus for decoding an encoded data block. The apparatus has a memory to store an encoded data block comprising codewords. The apparatus has scalable resources, which are configurable to accommodate at least two codeword lengths and at least two code rates. The apparatus has a decoder to decode the data block in a pipelined manner using a layered belief propagation technique and the scalable resources

A further exemplary embodiment in accordance with this invention is a device for decoding an encoded data block. The device has means for storing an encoded data block comprising codewords. Additionally, the device has means for providing scalable resources which are configurable to accommodate at least two codeword lengths and at least two code rates The device has means for decoding the data block in a pipelined manner using a layered belief propagation technique and the scalable resources.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows equations (1) through (10).

FIG. 2 shows equations (1) through (19)

FIG. 3 illustrates an optimal correcting offset in Modified Min-Sum for codes with different bit node and check node degrees.

FIG. 4A depicts a typical processing schedule (three consecutive layers).

FIG. 4B shows a two-stage pipeline schedule.

FIG. 4C shows a three-stage pipeline schedule.

FIG. 5 illustrates FER performance results for three-stage pipeline (code rate of ½, code size of 1296).

FIG. 6 illustrates FER performance results for three-stage pipeline (code rate of ⅔, code size of 1296).

FIG. 7 illustrates FER performance results for three-stage pipeline (code rate of ¾, code size of 1296).

FIG. 8 illustrates FER performance results for three-stage pipeline (code rate of ⅚, code size of 1296).

FIG. 9 shows a block structured irregular parity-check matrix with 24 sub-block columns and 8 block rows, code rate is ⅔.

FIG. 10 shows check memory modules (8-bit precision).

FIG. 11 shows a posteriori memory modules (8-bit precision).

FIG. 12 shows a part of ROM memory (for code rate of ½) used in a decoding iteration.

FIG. 13 shows a part of ROM memory (for code rate of ½) used from second to the last decoding iteration.

FIG. 14 depicts a block diagram of a scalable pipelined LDPC decoder.

FIG. 15 depicts a block diagram of a DFU with three pipeline stages.

FIG. 16 depicts a three-stage pipeline schedule (serial min-sum unit).

FIG. 17 depicts a block diagram of a serial min-sum unit.

FIG. 18 depicts a block diagram of a scalable four-stage permuter.

FIG. 19 depicts a block diagram of a parity-checking function unit.

FIG. 20 illustrates latency per decoding iteration as a function of the code rate (from ½ to ⅚).

FIG. 21 illustrates the average decoding throughput as a function of code rate for different codeword sizes.

FIG. 22 illustrates the frame error rate performance as a function of maximum number of iterations.

FIG. 23 illustrates the “normalized throughput” (maximum achievable throughput) for different code rates and codeword sizes.

FIG. 24 shows a simplified block diagram of various electronic devices that are suitable for use in practicing the exemplary embodiments of this invention.

FIG. 25 illustrates a method in accordance with an embodiment of this invention.

### DETAILED DESCRIPTION

Exemplary embodiments of this invention achieve high decoding throughput by pipelining the processing of multiple layers (or stages), for example three consecutive layers of the PCM. The decoding process is based on a LBP and can be divided into three stages (reading, processing, and writing stages) within the single layer of the PCM. The three different decoding stages for three consecutive layers can be executed simultaneously. Pipelining of multiple layers introduces only marginal performance loss in comparison with the original non-pipelined LBP.

A decoder in accordance with an embodiment of the present invention is scalable and supports three codeword lengths (e.g., 648, 1296, and 1944) and four code rates (e.g., ½, ⅔, ¾, and ⅚). Different codeword lengths can be supported with the identical control logic since the memories (check memory and APP memory) and DFUs are divided into banks that can be turned off for smaller codeword sizes. At the same time, a scalable permuter design performs shifting of blocks of different sizes (e.g., 27, 54, and 81), which correspond to the codeword lengths of 648, 1296, and 1944, respectively. Parts of permuters can be turned-off while permuting lower block sizes.

Furthermore, by storing the shifting offsets (i.e., the difference between shift values between two consecutive non-zero sub-matrices that correspond to the same sub-block column of PCM) instead of original shift values in ROM modules, a reverse permuter can be avoided before storing the APP messages in the memory. Consequently, approximately 16% less standard CMOS ASIC gates are used for the arithmetic part of decoder and a smaller decoding latency per iteration is also achieved.

Switching from one codeword length to another for fixed code rate can be fast (e.g., completed in several clock cycles) since only some parts of hardware (e.g., blocks of memories, banks of DFUs, and parts of permuters) will be turned off/on while the control logic is unmodified. Such a decoder supports the IEEE 802.11n standard where different sizes of OFDM packets are possible. Furthermore, supporting an early detection accelerates decoding throughput—parity of rows (e.g., check equations) is checked from layer to layer and decoding can be stopped at any layer inside the super-iteration. This decreases the average number of iterations, improves the average data throughput and reduces the power consumption. Further increase of the decoding throughput is achieved by deep pipelining of three consecutive layers.

These features are achieved by exploiting the block structure of the PCMs by applying a layered message-passing scheme that can achieve faster decoding convergence than a standard message-passing algorithm, and by pipelining of three consecutive layers.

The embodiments of this invention can be implemented within the designs of a scalable and structured LDPC decoder that can achieve high data throughput, fast decoding convergence, and support different code rates (e.g., ½, ⅔, ¾, and ⅚) and codeword lengths (e.g., 648, 1296, and 1944). Such a decoder can be an integral FEC part of the receiver for the next generation of wireless standards (in particular, IEEE 802.11n standard).

Exploiting the message-passing scheme based on layered BP algorithm insures faster decoding convergence comparing to standard BP algorithm (e.g., about twice as fast). The average data throughput is between 100 and 700 Mbits/sec, depending on the code rate and codeword length, which can be achieved by pipelining of multiple layers of PCM and by implementing early detection.

The flexibility of supporting three different codeword lengths can be achieved by exploiting the inherent block structure of the PCM. In the case of a fixed code rate the same control state machine is utilized while certain memory blocks, banks of decoding function units (DFUs) and parts of permuters will be turned on or off depending on the code size. Utilizing only small ROM modules (contain shifting offsets of the identity sub-blocks, and locations of these non-zero sub-blocks) supports four different code rates with small variations in the control logic.

Using an efficiently designed permuter for the permuting blocks (e.g., of size 27, 54, and 81), a suitable gate count is achieved while avoiding excessive hardware overhead (e.g., 3:1 multiplexers may be utilized instead of the larger and more commonly used 4:1 multiplexers). This avoids a potential disadvantage due to the large size of permuters required for block permutation of a posteriori probabilities. Implementation of multiple permuters may be used in order to achieve a high decoding throughput: multiple blocks of APP messages of large sizes may be permuted when loaded from the original and/or mirror memories.

A LDPC decoder in accordance with an embodiment of this invention can be implemented on a FPGA for fast prototyping and functional verification using a design tool such as the Xilinx System Generator. Using an automatic tool design-model the LDPC decoder can be automatically synthesized on the FPGA. A design environment, such as one based on the Xilinx System Generator, also may allow for parameterized implementation that can be efficiently reprogrammed on the same FPGA. The LDPC decoder may be designed as a structured and scalable ASIC implementation that can support multiple code rates and codeword lengths while achieving high data throughput. An ASIC implementation takes advantage of the high achievable throughput (ASIC can provide fast clock speed) and the ability to quickly switch from one codeword length to another. In such an implementation the arithmetic precision can be either 7 or 8 bits

A LDPC decoder in accordance with an embodiment of this invention can be used as a forward error correcting part of a receiver implementation in the IEEE 802.11n wireless standard. Such a decoder would be flexible to be able to support block-structured parity check matrices with variable code rates and codeword lengths required by the standard.

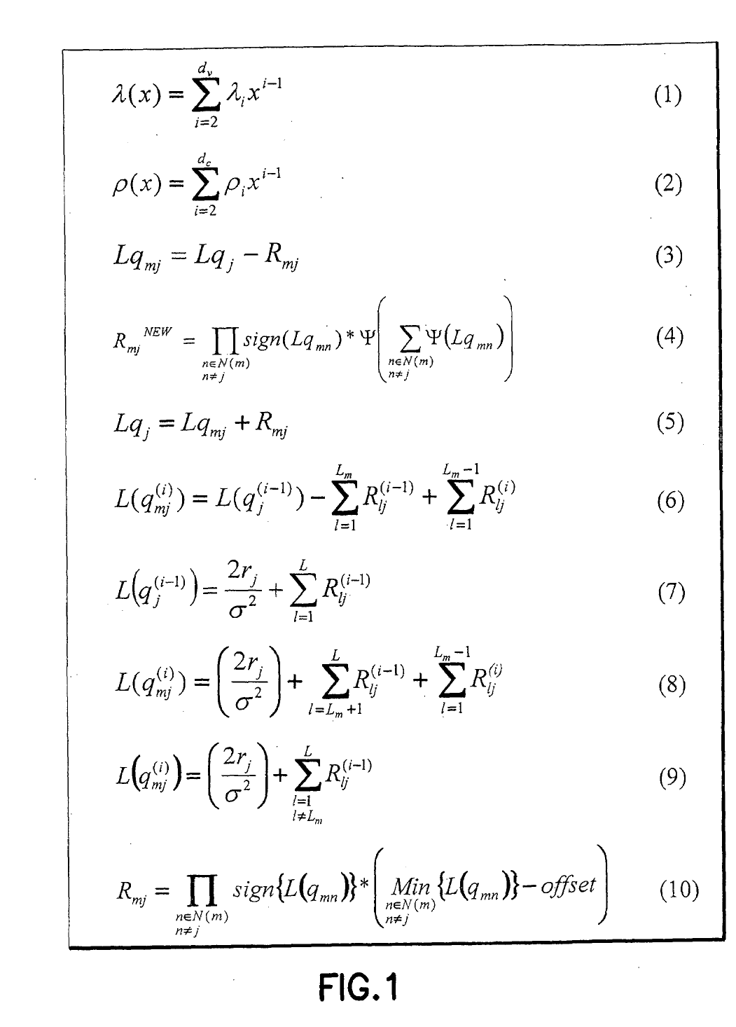

A LDPC code is a linear block code specified by a very sparse PCM where non-zero entries are typically placed at random. Irregular LDPC codes may be specified by equations (1) and (2) as shown in FIG. 1; where λᵢ is the fraction of edges in the bipartite graph that are connected to the bit nodes of degree i; ρᵢ is the fraction of edges that are connected to check nodes of degree i; and dᵥ and d_{c} represent the maximal bit-node and check-node connection degree, respectively.

A LBP algorithm may be used to decode the LDPC codes iteratively from one set of independent rows inside the PCM to another set. LLRs may be used as messages as detailed in S. Chung, T. Richardson, and R. Urbanke, “Analysis of sum-product decoding of low-density parity-check codes using a Gaussian approximation,” IEEE Trans. Inform. Theory, vol. 47, pp. 657-670, February 2001; and A. de Baynast, P. Radosavljevic, J. Cavallaro, and V. Stolpman, “Tight upper bound on the convergence rate of LDPC decoding with Turbo-schedules” submitted to IEEE Communications Letters, July 2007.

L(qₘⱼ) and Rₘⱼ denote output message of a bit and check node, respectively. The messages L(qⱼ) represent the LLRs of the APPs. A bit node receives messages from its M(j), j=2, . . . , dᵥ neighbors, processes the messages, and sends messages back to its neighbors. The message L(qₘⱼ) can be expressed as shown in equation (3) in FIG. 1.

Similarly, a check node may get messages from its N(m), N(m)=2, . . . , d_{c} neighbors, processes the messages, and sends the resulting messages back to its neighbors. The check node update rule can be expressed as shown in equation (4) in FIG. 1; where Ψ(x)=−log(|tan h(x/2)|).

The tentative APP ratio for each bit node is equal to equation (5) in FIG. 1.

This three-stage procedure is executed from layer to layer and may be repeated many times. At the very beginning, L(qⱼ) is initialized with the channel LLR (LLRⱼ=2rⱼ/σ²) of the j-th output bit associated with the bit node. The noise variance of the channel is denoted σ².

An advantage of LBP algorithm is better message scheduling. Decoding convergence is approximately twice faster. For any layer Lₘ (Lₘ=1, . . . ,L), and iteration i it can be shown that the LLR of bit node messages can be computed as shown in equation (6) in FIG. 1

In addition, a layered message passing algorithm is identical approximation of a belief propagation algorithm as a standard messages passing scheme. Therefore, the LLR APP of the j-th bit node at the end of iteration i is given by equation (7) in FIG. 1.

Combining Eq. 6 and Eq. 7 produces equation (8) in FIG. 1.

On the other hand, in standard belief propagation algorithm, the LLR of bit node messages are determined as shown in equation (9) in FIG. 1.

Equation (8) shows that in a LBP algorithm previously updated check messages from previous layers (1, . . . ,Lₘ−1) are used within the same iteration to update bit node messages from layer Lₘ. This is not the case in SBP algorithm where only the check messages from the previous iteration are utilized (see Equation 9). Mathematically, this leads to a faster convergence of the LBP decoding algorithm.

The updating of check messages in (4) is sensitive to the fixed-point precision due to nonlinear function Ψ(ΣΨ(Lqₘₙ)). For the purpose of fixed-point implementation it is more suitable to approximate this function with the absolute minimum of the bit node messages in particular row of the PCM. See: F. Zarkeshvari, A. H. Banihashemi, “On implementation of min-sum algorithm for decoding low-density parity-check (LDPC) codes”, IEEE Global Telecommunications Conference, November 2002, pages 1349-1353; Manyuan Shen, Huaning Niu, Hui Liu, J. A. Ritcey, “Finite precision implementation of LDPC coded M-ary modulation over wireless channels”, Asilomar Conference on Signals, Systems and Computers, 2003, November 2003, pages 114-118; M. Karkooti and J. Cavallaro, “Semi-parallel reconfigurable architectures for real-time LDPC decoding”, IEEE ITCC, April 2004.

This approximation introduces some loss in comparison with the original belief propagation algorithm, but it is more robust to the quantization error since the error does not depend on the horizontal connectivity degree (number of bit nodes per row): only the two smallest elements are considered. This solution is robust to the quantization error for any code rate (typically horizontal connectivity degree W_{R} is increasing with the code rate).

By using the appropriate correction term (offset) the approximation error is significantly reduced. The updating of check messages per row of PCM is now determined by equation 10 in FIG. 1.

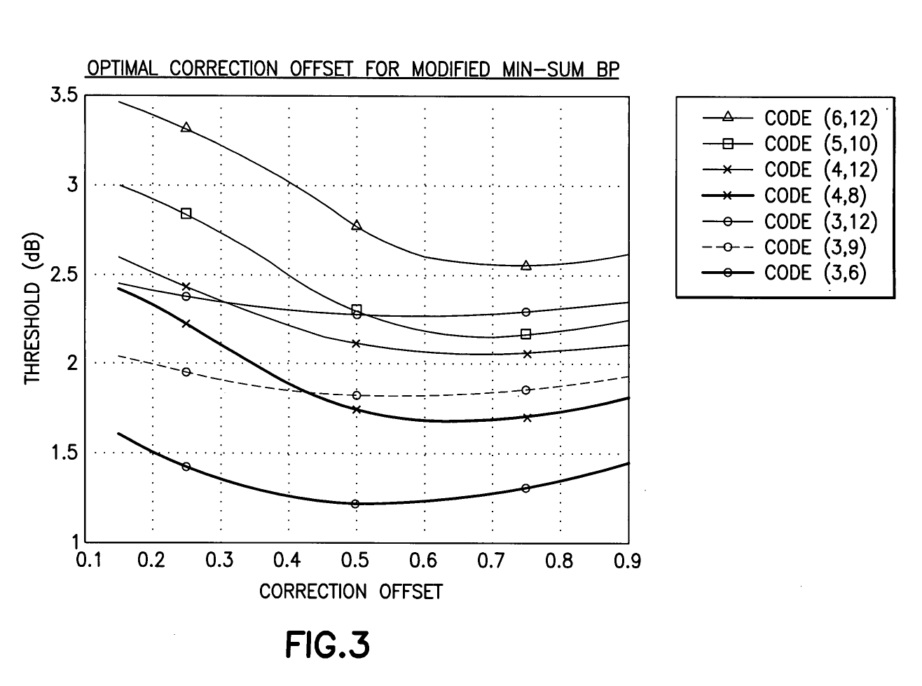

Better decoding convergence can be achieved if the correction factor (offset) is carefully chosen. In order to determine a suitable correcting offset, density evolution is applied for some standard regular codes with different code rates (e.g., ½, ⅔, ¾) and pairs of column and row connectivity degrees (W_{c}, W_{R}). The minimum threshold for perfect error correction is determined as a function of the correcting offset. FIG. 3 shows that the correction term varies with the row connectivity degree W_{R}, but also it can be noticed that the value of 0.5 is the best tradeoff for different codes. This solution is also suitable for a fixed-point implementation since only one fractional bit is needed to represent the correcting offset.

The decoding process can be divided into three pipeline stages that can be executed simultaneously for three different layers: reading (R), processing (P), and writing (W) stages.

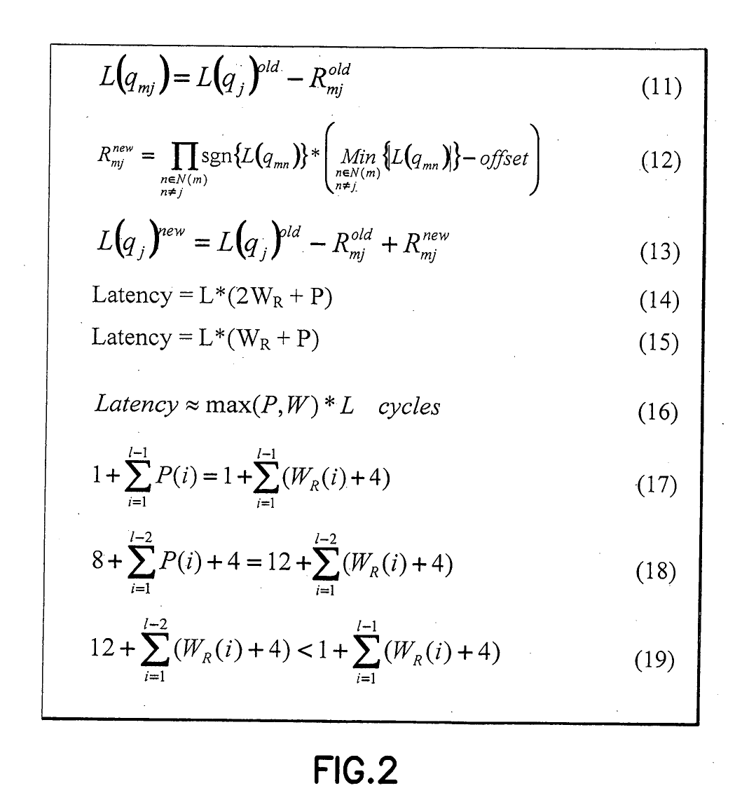

Reading (R): reading (e.g., loading from the memory) old LLR of a posteriori probabilities L(qⱼ) and old (not yet updated) check node Rₘⱼ messages, and updating bit node L(qₘⱼ) messages, see equation (11) in FIG. 2.

Processing (P): updating check node messages using modified min-sum algorithm for every row inside the current layer, see equation (12) in FIG. 2.

Writing (W): updating of a posteriori L(qj) messages and memory storage (also storage of the updated check messages), see equation (13) in FIG. 2.

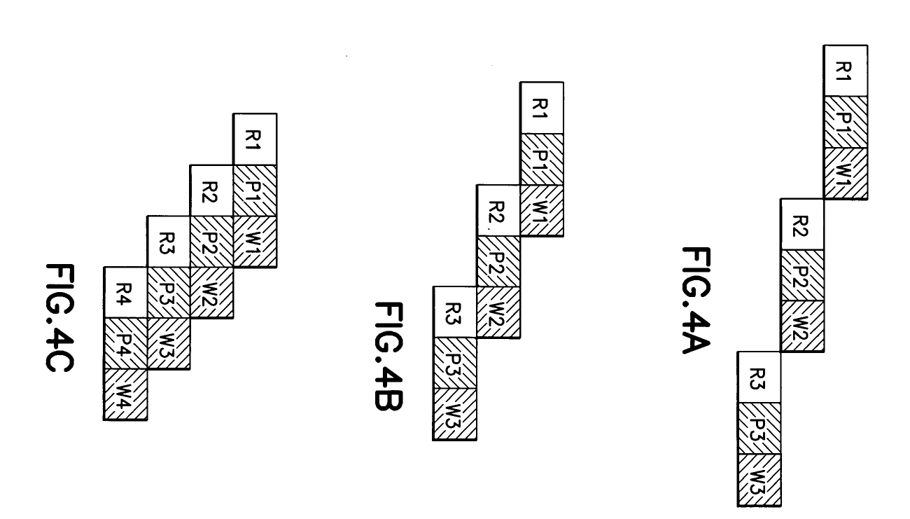

In an original layered belief propagation algorithm no pipelining of layers is used: all three stages that belong to the current layer must be finished before processing the next layer, as it is shown on FIG. 4A for three consecutive layers. There is no pipelining of the three stages: memory read (R1, R2 and R3) stage, process (P1, P2 and P3) stage and memory write (W1, W2 and W3) stage.

In accordance with an embodiment of this invention, the latency (per iteration) is determined by the sum of: reading latency, processing latency, and writing latency. The memory is organized in such a way that it is possible to read/write one sub-matrix (shifted identity matrix inside the PCM) in one clock cycle. The total read/write latency per one layer is W_{R} since there are W_{R} sub-matrices inside one layer (W_{R} is the row degree). Decoding latency per iteration is shown by equation (14) in FIG. 2; where L is the total number of layers and P is the processing latency.

In order to increase the throughput, different stages of multiple layers can be executed simultaneously. The latency of these three pipeline stages is well balanced (e.g., approximately the same). On the other hand, some error-rate performance loss may be experienced since multiple layers are overlapped and executed simultaneously.

Decoding throughput may be improved by pipelining the memory reading for the current layer with the memory writing of the updated messages for the previous layer. Consequently, there are two pipeline stages: memory read (R1, R2 and R3) and process (P1, P2 and P3) stage and memory write (W1, W2 and W3) stage, as it is shown on FIG. 4B.

Decoding latency per iteration is determined by the memory read latency and the processing latency as shown by equation (15) in FIG. 2.

With some additional control logic overhead (e.g., decoding logic and the memory organization are still the same), it is possible to pipeline all three stages (memory read (R1, R2 and R3), process (P1, P2 and P3), and memory write (W1, W2 and W3) stages), as it is shown in FIG. 4C. In this case the latency per iteration depends only on the processing latency.

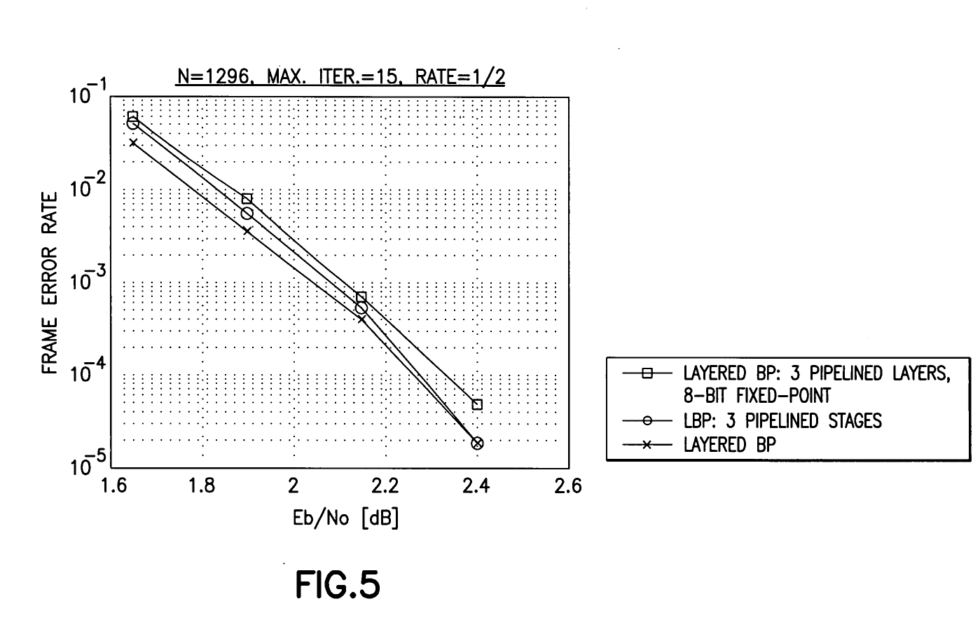

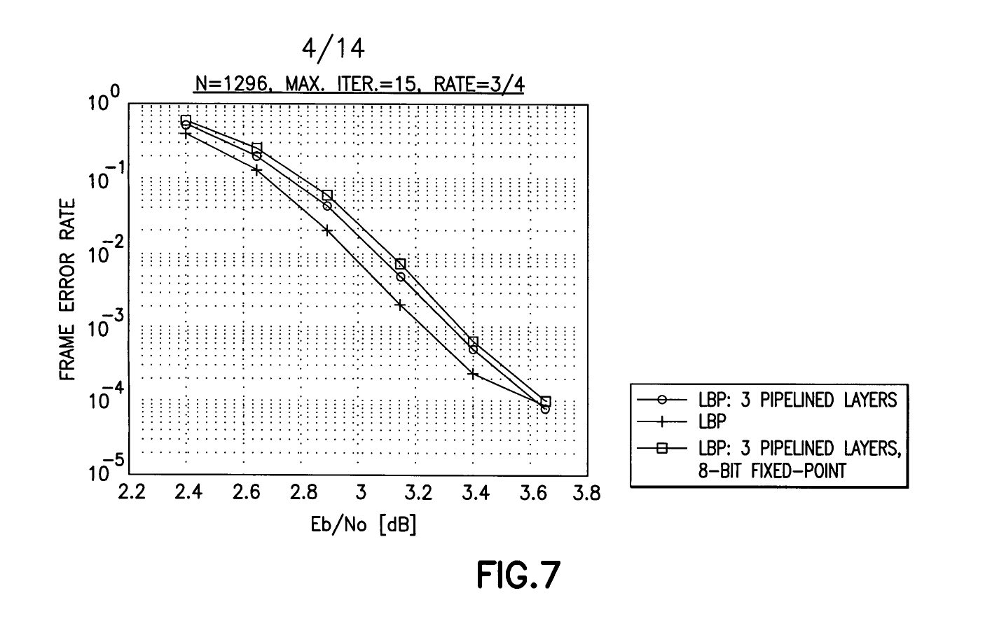

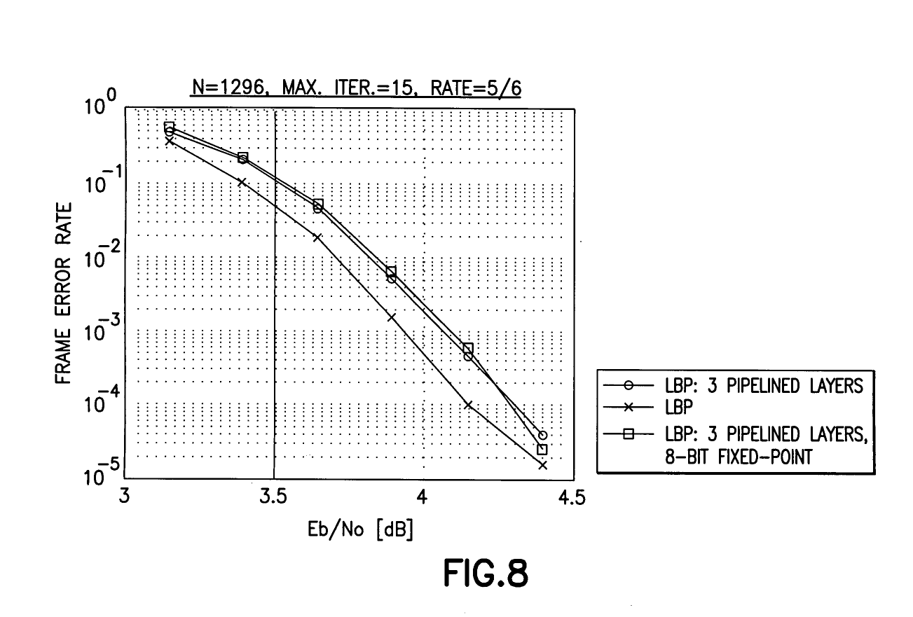

A decoder in accordance with an embodiment of this invention supports simultaneous execution of three consecutive layers (e.g., pipelining of all three stages). The FER results (e.g., in both floating and 8-bit fixed-point implementation) show only small performance loss comparing to non-pipelined version of LBP decoding algorithm. The FER performance curves for rates ½, ⅔, ¾ and ⅚ are presented in FIGS. 5, 6, 7 and 8, respectively (codeword length is 1296 for all rates). Furthermore, for code rates of ½ and ⅔, the scheduling of layers is applied: performances are improved since the overlapping between the consecutively processed layers is reduced. For higher code rates (¾, and ⅚) with small number of layers (6 and 4) the layer scheduling is not as effective.

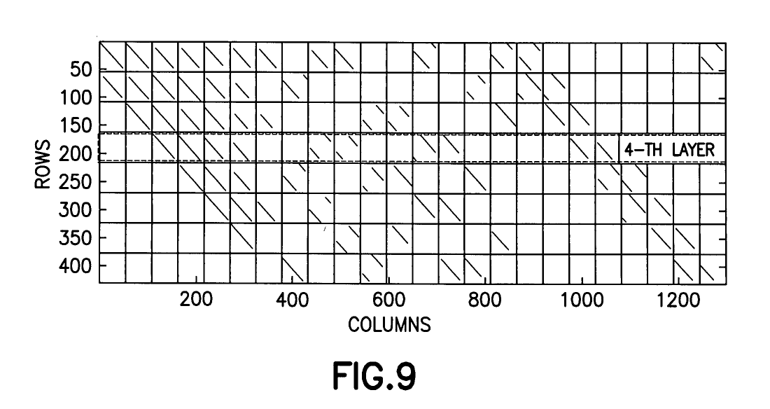

A scalable high throughput LDPC decoder based on layered belief propagation is designed. Such a decoder supports block structured PCMs with 24 sub-block columns as shown in FIG. 9 and as proposed in V. Stolpman et al., “LDPC coding for OFDMA PHY” Tech. Rep. IEEE C802.16e-04/526, IEEE 802.16 Broadband Wireless Access Working Group, 2004.

FIG. 9 shows a block structured irregular parity-check matrix with 24 sub-block columns. The codeword size, N, is 1296 and the rate is ⅔. Eight layers are shown where the sub-block matrix size is 54×54.

Possible code rates include ½, ⅔, ¾, and ⅚, while codeword sizes of 648, 1296, and 1944 are supported. These code rates and codeword sizes are defined by the IEEE 802.11n standard. Pipelining of three consecutive layers is assumed in order to achieve high deciding throughput (e.g., about 600 Mbits/sec with the clock frequency of 200 MHz). A layer can be defined as a set of independent rows (parity check equations that can be processed independently without performance loss) with up to one non-zero entry per column.

As it is shown in FIG. 9 block structured PCMs supported by the proposed decoder consist of sub-block matrices that are shifted versions of the identity matrices. The size of the sub-block matrix is scalable and depends on the codeword size: 27×27, 54×54, and 81×81 for the codeword sizes of 648, 1296, and 1944 respectively.

High decoding throughput can be achieved by loading one full sub-block matrix every clock cycle from check memory (e.g., all check messages that correspond to the sub-block matrix are loaded) and a posteriori memory (e.g., all LLR APPs that correspond to the sub-block matrix are read). This process can be repeated for all non-zero sub-block matrices in the current layer l and all bit-node messages inside the layer can be updated according to equation (11) as shown in FIG. 2. At the same time, previous layer l−1 is processed: all check messages inside that layer are updated according to equation (12) as shown in FIG. 2. Simultaneously, in every clock cycle, newly updated sub-block matrices for layer l−2 are stored in check memory (correspond to the updated check messages per non-zero sub-block matrix) and in a posteriori memory (correspond to the updated LLR APPs per sub-block columns, see equation (13) as shown in FIG. 2 for the updating rule)).

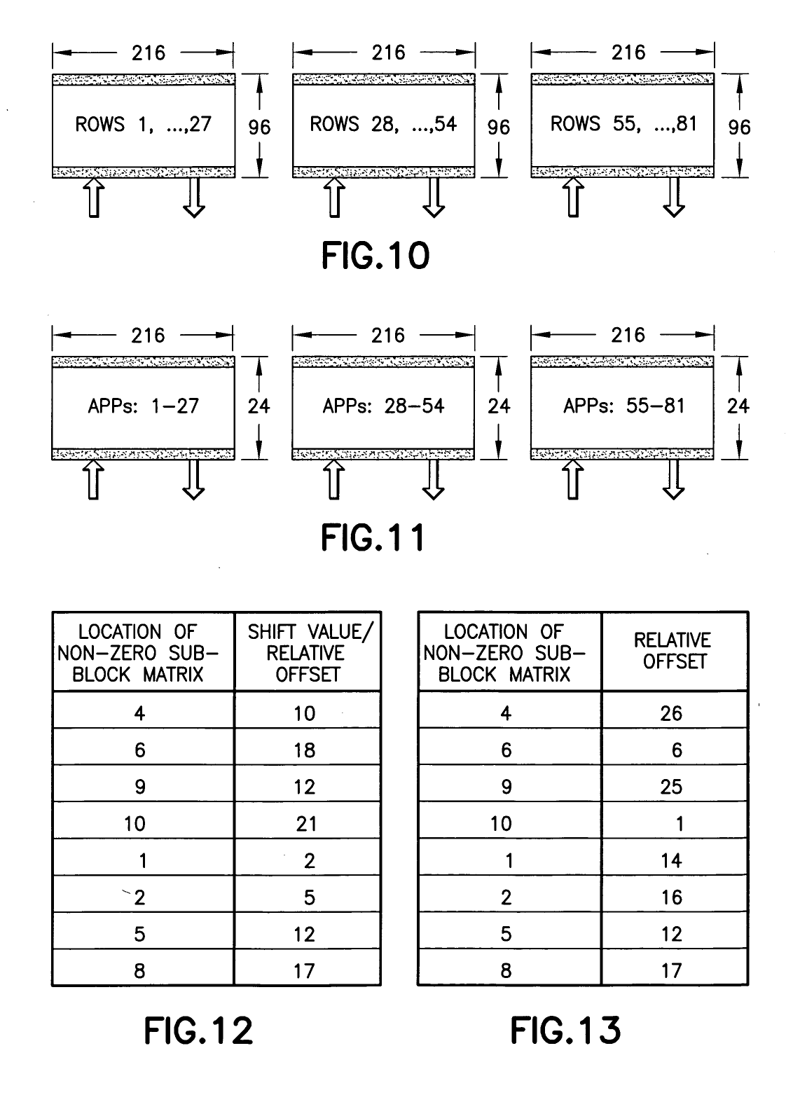

To be able to read/write one full sub-block matrix per clock cycle, the check memory and the a posteriori memory need to be organized in the appropriate manner. Organization of the check-node memory is shown in FIG. 10, and organization of the a posteriori memory is shown in FIG. 11.

Check memory is divided into three modules where every memory module stores in every location 27 check messages from the sub-block matrix (the width is 216 bits since every message is represented with 8 bits). In the case of the largest codeword size of 1944 all three check memory sub-modules will be used, while only two and one module will be used in the case of codeword sizes of 1296 and 648 respectively. The unused check memory modules can be turned-off. The depth of the check memory sub-modules depends on the number of layers and number of non-zero sub-block matrices per layer (row connectivity degree). The largest depth for code rate of ½ is 96 since there are (in average, because of the code irregularity) eight non-zero sub-block matrices per layer and there are 12 layers. The addressing of check messages is very simple since the memory locations are always accessed in the increment order.

During the write stage old check messages (e.g., those not yet updated) have to be utilized, as well as the updated check messages, see equation (13) as shown in FIG. 2. Since the pipelining of three consecutive layers is also employed, the large numbers of check messages from the previous layers are buffered while waiting to be utilized. In order to avoid large buffering a mirror check memory is used to buffer old check messages from the previous layers. Old check node messages are loaded directly from the mirror memory before being updated.

There is a constant address-offset between the original and mirror check memories, since the reading from the mirror memory is typically two layers behind the reading from the original memory. For accurate processing, both the mirror and the original memory need to be updated at the same time.

There are also two a posteriori memories for storage of a posteriori probabilities—the original one and the mirror memory. Both memories are updated at the same time with the newly computed a posteriori probabilities (see equation (13) as shown in FIG. 2). The mirror memory is able to read a posteriori probabilities that correspond to the layer l−2 while at the same time a posteriori probabilities from layer l are loaded from the original memory.

Both memories are identical and they are divided into three sub-modules. Every memory location in the sub-module contains 27 a posteriori probabilities (one third of the largest 81×81 sub-block matrix, the module width is 216 bits since every message is represented with 8 bits). Three APP sub-modules (original and mirror) are utilized in the case of codeword size of 1944, while one or two sub-modules are turned-off in the case of 1296 and 648 codeword sizes, respectively. The depth of the APP memory sub-modules is equal to 24, the number of sub-block columns in the PCMs.

Check memory is composed of 3+3 RAM modules (original and mirror): every RAM module is 216 bits wide, 96 locations deep (for 8-bit implementation). The mirror is chosen to avoid large buffering. A posteriori memory is composed of 3+3 RAM modules: 216 bits wide, 24 locations deep (8-bit implementation). Division into the larger number of smaller modules is also possible.

The block-structured PCMs are stored in a compact form in ROM modules. Since the PCMs for all supported code rates and codeword sizes are different, multiple ROM modules are required. The ROM modules store the sub-block column positions of the non-zero sub-block matrices (possible values are between 1 and 24 since the supported PCMs have 24 sub-block columns). Furthermore, every non-zero position needs to be accompanied with the shifting value to shift blocks of APP messages when loaded from memory.

In order to avoid the reverse permutation before storing the updated APP messages back in the memory, the relative offsets between two consecutive shift values that correspond to the same block-column are stored in memory, e.g., ROM modules. Only in the first iteration (in the case when certain block columns are loaded from the memory for the first time) are the original shift values also stored.

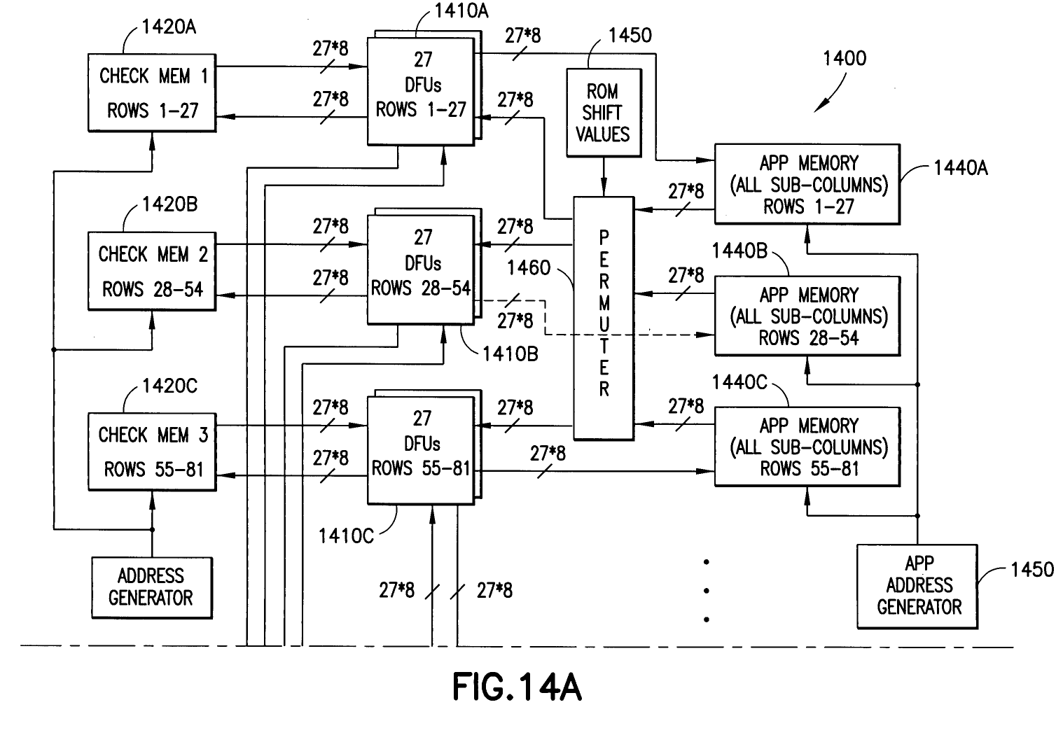

Examples of two ROM modules (part of modules that are used in the first and remaining decoding iterations) in the cases where the code rate is ½ are shown in FIGS. 12 and 13. Two ROM modules are used for every code rate that is supported. Location of the non-zero sub-block matrix (block of APP messages) represents the address in the APP memory. The address counter uses these stored values in order to jump to the appropriate address. In addition, the control logic may use the information about the number of layers for every supported code rate, as well as the information about the number of non-zero sub-block matrices per every layer.

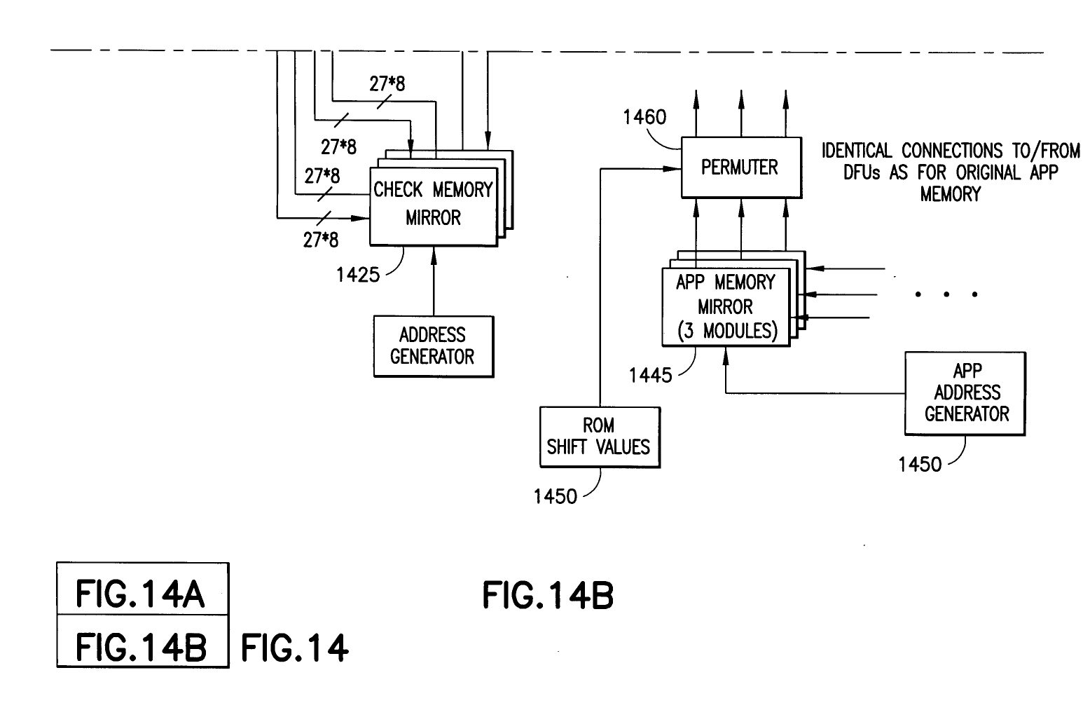

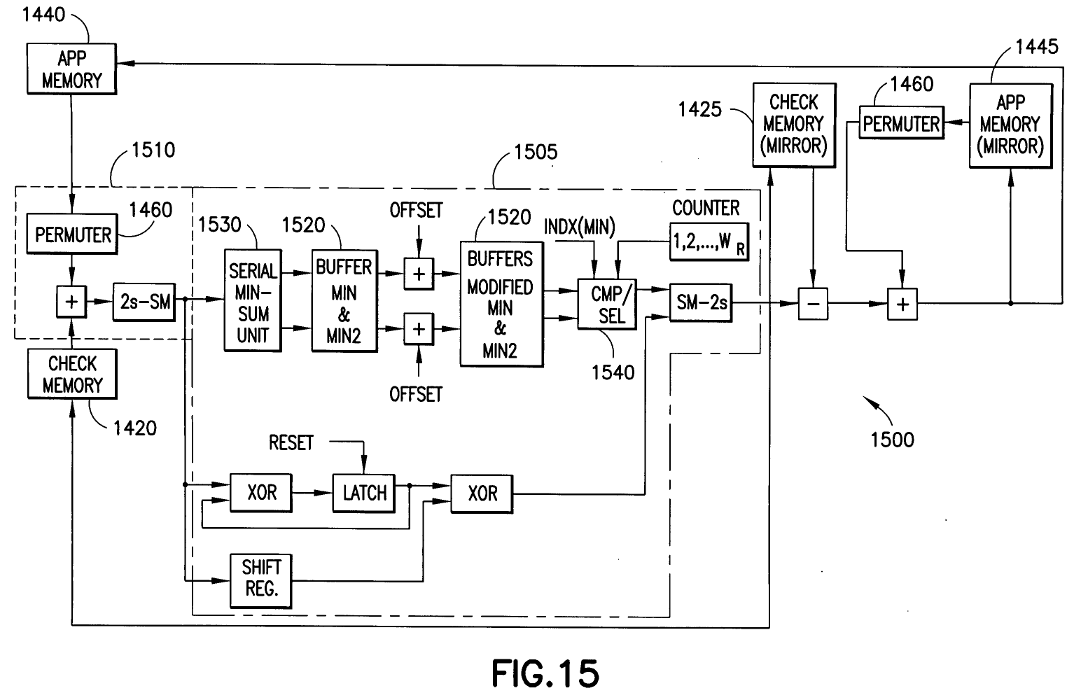

FIG. 14 shows a block diagram of a scalable structured LDPC decoder 1400 in accordance with an embodiment of this invention based on LBP and pipelining of layers. There are three banks of DFUs 1410A, 1410B and 1410C where each bank consists of 27 DFUs 1500 (shown in FIG. 15). The DFUs 1500 represent the main arithmetic part of decoder and they are used to update a posteriori messages and check node messages according to equations (11)-(13). The number of DFUs 1500 corresponds to the number of rows in the PCM inside one layer: 27, 54, and 81 for the codeword sizes of 648, 1296, and 1944 respectively. It can be observed that all three DFU banks 1410A, 1410B and 1410C are utilized for the largest codeword size; otherwise one or two DFU banks 1410A, 1410B and 1410C may be disabled. Since the number of DFUs 1500 corresponds to the number of rows per layer, proposed semi-parallel decoder architecture can achieve full decoding parallelism per one layer.

All check messages inside the sub-block matrix are loaded from the appropriate check memory location during the single clock cycle. As shown in FIG. 10, in every clock cycle the check messages are loaded from up to three separate check memory modules 1420A, 1420B and 1420C. Every check message is represented with 8 bits (alternatively, 7-bit precision can be used), and there are 27 check messages per memory location (this number corresponds to one third of the largest 81×81 shifted identity matrix). The same check messages are stored back in every check memory module 1420A, 1420B and 1420C after being updated in the appropriate DFU 1500. The mirror check memory 1425 is used to load the check messages from one of the previous layers in order to update the a posteriori messages (writing stage, see equation (13), these messages are labeled as Rₘⱼ^{old}). By using the mirror memory 1425 large buffering of old check messages is avoided. The content of both memories is identical, and both memories need to be updated at the same time with the same check messages.

As noted above, a posteriori memories, both original (1440A, 1440B and 1440C) and mirror 1445, are also divided into three sub-modules: all three sub-modules are used in the case of a codeword size of 1944, while in the case of 1296 and 648 code sizes one or two sub-modules may be turned-off in order to save power dissipation. Before being routed to the appropriate DFU 1500 (to be accompanied with the corresponding check node messages), the APP messages have to be permuted in the permuter 1440 using the shift value stored in the appropriate ROM memory 1450 (the shift value corresponds to the shifted identity matrix). A second permuter 1465 is required at the output of the APP mirror memory 1445. Both mirror 1445 and the original APP memories 1440A, 1440B and 1440C are updated with the same content: the same newly computed APP messages.

Both permuters 1460 and 1465 are identical and scalable in order to support block shifting of three different block sizes (27, 54, and 81). A reverse permuter is avoided: the updated APP messages out of DFUs 1500 are stored directly in the original 1440A, 1440B and 1440C and mirror 1445 APP memory. To achieve this, the relative differences (shifting offsets) between two consecutive shifting values that correspond to the same sub-block column need to be stored in the ROM module 1450.

The APP address generators 1450 (for reading and writing of APP messages) are responsible for the appropriate addressing of APP memory 1440A, 1440B 1440C and 1445. The ROM modules 1450 also contain the sub-block column position (from 1 to 24) of the corresponding non-zero sub-block matrices, which is identical to APP memory address.

The block diagram of DFU 1500 is shown in FIG. 15. A decoding function unit processes (decodes) one full row of the PCM in three pipelined stages according to equations (11)-(13). In order to achieve full decoding parallelism per one layer there are 81 DFUs 1500 divided into three separate banks 1410A, 1410B and 1410C, as it is shown in FIG. 14. The blocks that correspond to three different pipeline stages are shown in FIG. 15 in different section, 1505, 1510, and the remainder.

During the first stage 1505 the messages (check messages and APP messages) from the current l-th layer are loaded from APP 1440 and check memory 1420 (both memories are the original memories), the previous layer l−1 is processed (all check messages in the row are updated), and the APP messages for layer l−2 are updated and stored back in the original 1440 and mirror APP memories 1445 (as well as check messages for layer l−2). All hardware blocks in FIG. 15 have latency of one clock cycle (including load/store of one sub-block matrix from/to memory) except the following two blocks: permuter 1460 has initial latency of four clock cycles and after that in every clock cycle new set of permuted messages is generated, and serial min-sum unit 1520 has latency of W_{R} cycles (depending on the number of bit node messages per row).

Next, the second pipeline stage 1510 is entered. After loading of check messages and APP messages from the appropriate memory modules 1420, 1425, 1440, 1445 (one sub-block of messages per clock cycle, and APP messages have to be permuted), one or more new bit node messages may be updated every clock cycle (according to equation (11)), and converted from two's complement to sign-magnitude representation. Although only one bit node message in the current row of the PCM is updated, the serial min-sum processing can start.

The serial min-sum unit 1520 searches for two smallest bit node messages (in the absolute sense) within the current row and keep track of their indexes. After W_{R} clock cycles two minimums are found and stored in the buffer 1530. After that, they are modified by using the correcting offset (e.g., 0.5) and saved again in the buffer 1530 to be used afterwards. Compare/select block 1540 compares in every clock cycle the index of the check message (e.g., possible index value is between 1 and W_{R}, and it is generated with the counter) with the index value of the smallest bit node message (smallest value in the absolute sense), and then chooses either the smallest absolute value or the second smallest absolute value. Consequently, in every clock cycle the updated absolute value of the check message is generated. After including corresponding sign-product value, two's complement version of the check messages are computed in every clock cycle (see equation (12) for the check message updating rule).

This is the start of the third pipeline stage. From the mirror check memory 1425 and mirror APP memory 1445, old (not yet updated) check messages and APP messages are loaded (APP messages are also permuted), and the same APP messages are updated. In addition, the updated check messages (from the second pipeline stage), and the newly updated APP messages are stored in both mirror (1425 and 1445) and the original memories (1420 and 1440), as shown in FIG. 15.

The designed state machine, besides controlling the pipelining of three consecutive layers, it is also responsible for controlling in what clock cycle reading/writing of reliability messages to/from memory is performed. For example, if writing of an updated APP message that belong to the layer l−2 starts in clock cycle T_{W}, reading of an APP messages from mirror memory for layer l−2 starts in cycle T_{W}−5 (permuter 1460 has four stages and latency of four cycles). Furthermore, the updated check message for layer l−2 has to be written in both check memories (1420 and 1425) one cycle after old check message (the same check message as the updated one) is loaded from the mirror check memory 1425.

The first updated check message is available in cycle T_{W}−2 (writing in the both check memories starts during the same clock cycle), and therefore the reading from the check memory mirror 1425 for layer l−2 starts one cycle before (in cycle T_{W}−3). Writing of updated APP messages for layer l−2 starts before reading of APP messages for layer l, which overcomes the problem of reading-writing memory conflicts

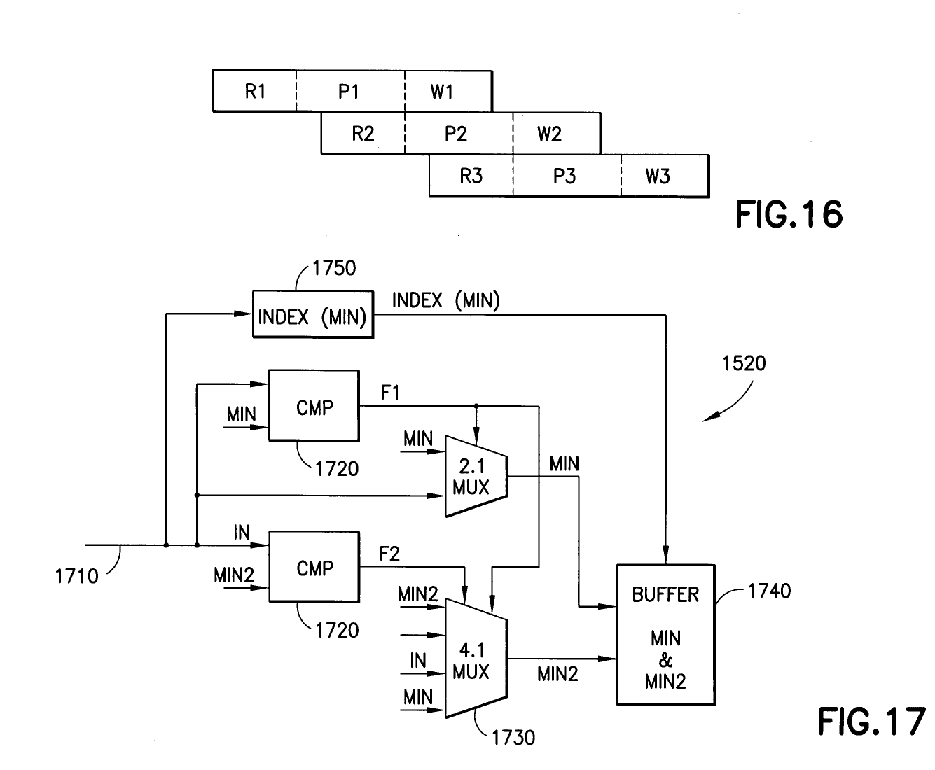

Three different pipeline stages that belong to three consecutive layers (not necessarily in the original order) are performed simultaneously. Because of the serial min-sum approach, there is an overlapping between Reading (R) and Processing (P) stages as it is shown on FIG. 16. The pipeline stages are not clearly separated, but overlapped. The serial min-sum computation (part of the processing stage) may start once as the first pair of updated variable-node messages for particular layer is available. In addition, there is also a stall (e.g., a few clock cycles) between memory readings of two consecutive layers since the previous layer has to finish serial min-sum processing. The writing of layer l−2 (writing of APP messages that belong to layer l−2) starts before reading of APP messages of layer l.

A designed serial min-sum unit 1520 used inside a DFU 1500 is shown in FIG. 17. The serial min-sum processing unit 1520 may be used to find the two smallest bit node messages per row of PCM (in the absolute sense). Every clock cycle the absolute value of updated bit node message is available at the input 1710 of the serial min-sum unit 1520. Every clock cycle the input bit node message is compared with the stored two smallest values, Min and Min2, and the set of minimums is updated accordingly. The latency of the comparators 1720 and the 4:1 multiplexer 1730 may be a single clock cycle. After W_{R} clock cycles the final set of minimums, Min and Min2, can be buffered in the buffer 1740, as well as the index (between 1 and W_{R}) Of the smallest bit node message Min can be buffered in the buffer 1750.

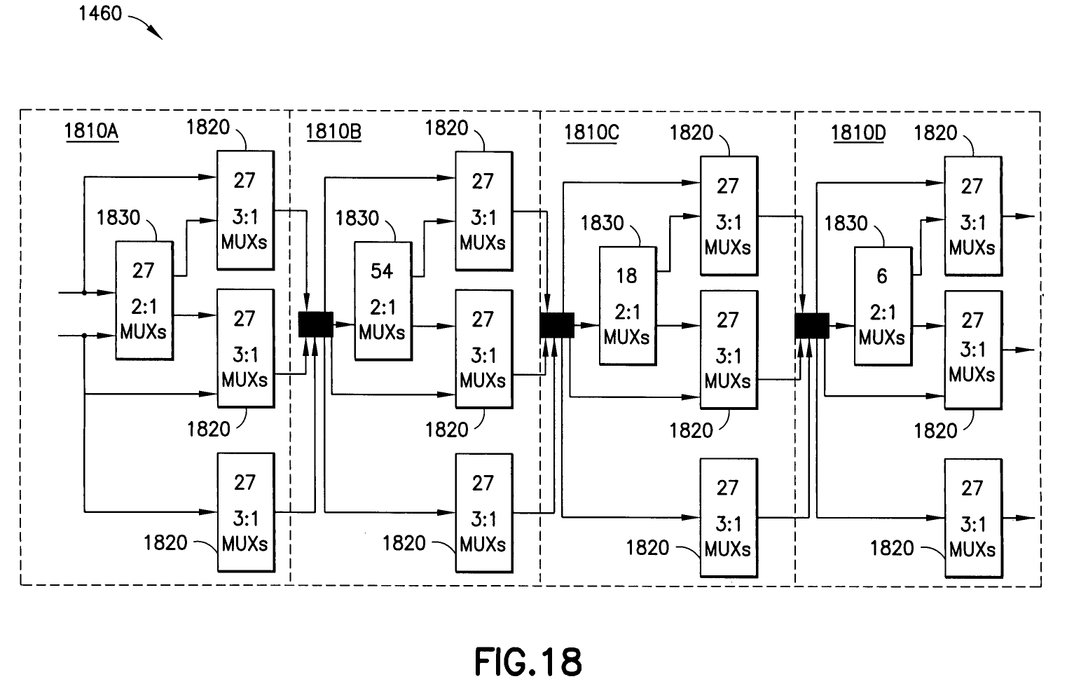

A scalable permuter 1460 performs permutation of blocks of three different sizes: e.g., 27 (codeword size of 648), 54 (codeword size of 1296), and 81 (codeword size of 1944). In particular, the blocks of APP messages (e.g., of sizes 27, 54 or 81) need to be permuted after loaded from the APP memories (original and mirror memory). A scalable permuter 1460 is shown in FIG. 18. It consists of four stages 1810A-1810D of 81 3:1 multiplexers 1820 used to permute blocks of size 81. In order to permute blocks of sizes 27 and 54 the additional 2:1 multiplexers 1830 are used before every stage of 3:1 multiplexers 1820.

The select signal used to select appropriate inputs in the multiplexers is a representation of the shift value from the seed PCM in the arithmetic representation with a base of three. In the first stage the possible shifting values include 0, 27, and 54. For example, if the block size is 27 the shift value in the first stage will be 0 (no shifting to be done in the first stage), while in the case of block size of 54 the shift value is either 0 or 27. For the second stage the possible shifting values are: 0, 9, and 18; for the third stage: 0, 3, and 6; for the fourth stage: 0, 1, and 2.

The latency of a permuter 1460 may be four clock cycles, where the maximum clock is determined by the delay through the chain of 2:1 and 3:1 multiplexers 1820 and 1830. Furthermore, there are four pipelined stages and after initial latency of four cycles, every next clock generates a new permuted block. A permuter 1460 permutes blocks of sizes up to 81, and in the case of smaller sizes (e.g., 27 and 54) roughly two thirds (in the case of 27) or one third (in the case of 54) of the permuter 1460 can be turned-off or disabled in order to save power.

The number of estimated standard logic ASIC gates for the proposed scalable permuter is about 34 KGates. The extra hardware of 2.5 KGates is needed to add scalability feature (the additional 105 2:1 multiplexers). See M. Mansour and N. Shanbhag, “High-throughput LDPC decoders,” Very Large Scale Integration (VLSI) Systems, IEEE Transactions on, vol. 11, pp. 976-996, December 2003; and N. H. E. Weste and E. Kamran, “Principles of CMOS VLSI Design: A Systems Perspective”, Second Edition, 1994.

The total number of estimated standard logic ASIC gates for the arithmetic part of a scalable LDPC decoder 1400 (which includes two permuters 1460 and 81 DFUs 1520) is about 160 KGates. In addition there are 3+3 RAM modules for check memory 1420 with total size of about 64 Kbits, and 3+3 RAM modules for APP memory 1440 with total size of about 15 Kbits. The additional ROM modules are required for storage of seed PCMs for all rates.

Early detection (parity checking) may also be applied. Therefore the decoding can be stopped after any layer. This feature significantly lowers the average number of iterations and further increases the decoding throughput. In order to hide the latency of checking parity, the stopping criterion for every row is checked during the decoding process.

During the updating of APP messages the following may be done: checking if parity check equations are satisfied for every row inside the current layer; and comparing sign of the updated APP messages with the signs of loaded old (not yet updated) APP messages (from the mirror memory).

The layer is valid if all parity check-equations inside one layer are satisfied, and also if all signs of the updated APP messages are not modified (all signs are the same).

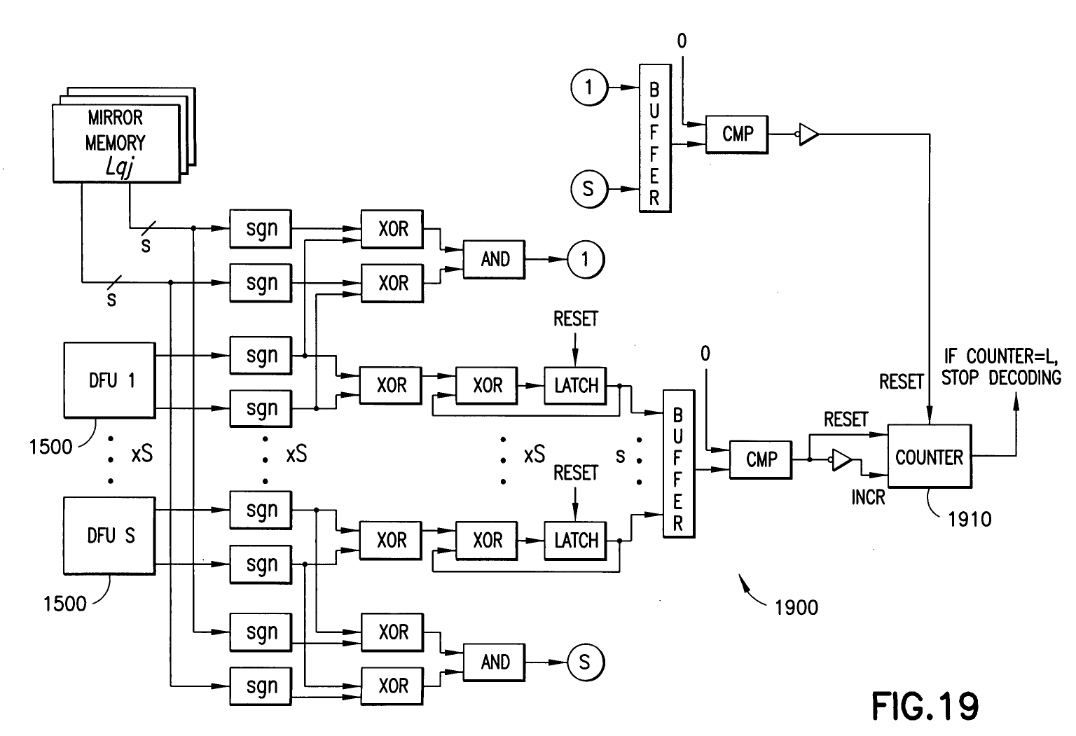

The block diagram of the parity checking function unit 1900 is given on FIG. 19. The counter 1910 is used for counting the number of valid layers. The counter 1910 counts from 0 to L, where L is the total number of layers, and corresponds to the number of layers that pass both the parity and the sign checking. The counter 1910 is incremented if parity check-equations for the current layer are satisfied. On the other hand, it is reset if the parity check-equations are not satisfied. It is reset if at least one sign of updated APP messages is modified. If counter 1910 is equal to L, all layers in the parity check matrix are valid, and the decoding can be stopped.

The latency of the parity checking processing is only several clock cycles for the last sub-block matrix inside the layer. This latency is practically invisible since there is already a time gap between updating of the successive layers.

The following hardware resources may be used for the implementation of parity-checking function unit (S is the size of sub-block, and it is equal to 81): 4S one-bit comparators, three S-bit latches, 4S 2-bit XORs, counter (5-bit buffer and increment unit), and S two-bit AND gates. The total number of standard ASIC gates is approximately 6 KGates.

Although LBP has faster decoding convergence than SBP, the maximum achievable processing parallelism is full parallelism per one layer. As noted above, in order to achieve about three times higher decoding throughput simultaneous processing (pipelining) of three consecutive layers is used. While the decoding throughput is significantly increased, the frame error rate performances suffer only small loss for all supported code rates.

In order to estimate the achievable decoding throughput, the computational latency per decoding iteration is determined. Based on the computational latency, the average decoding throughput (determined by the average number of iterations) as well as the maximal and minimal achievable throughput (determined by single and maximum number of iterations, respectively) can be computed.

The full processing latency per iteration depends on the number of layers L in the PCM, and on the latencies of three pipeline stages (reading—R, processing—P, and writing—W). Given a clock frequency of 200 MHz, it means that the latency of one clock cycle is determined by a computational delay of up to 5 ns.

The latency of the reading stage from when the first non-zero sub-block matrix inside the layer is loaded from the memory to when the last bit node message is updated and converted into sign-magnitude is: W_{R}+7 clock cycles (where W_{R} is the check node connectivity degree), see FIG. 15. This latency is not fully visible since the processing stage (min-sum processing) can start after the first updated bit node message is available at the input of serial min-sum FU. The processing latency P is determined by the latency of a serial min-sum unit (W_{R} clock cycles), and the latency of additional buffering and offset-correction: totaling W_{R}+4 clock cycles. The latency of the writing stage W is determined by the number of updated sub-block matrices per layer to be stored in the appropriate memories (W_{R} of them), and additional computational latency of 3 clock cycles: totaling W_{R}+3 clock cycles, see FIG. 15.

The full decoding latency per iteration is (because of pipelining) determined as shown by equation (16) in FIG. 2.

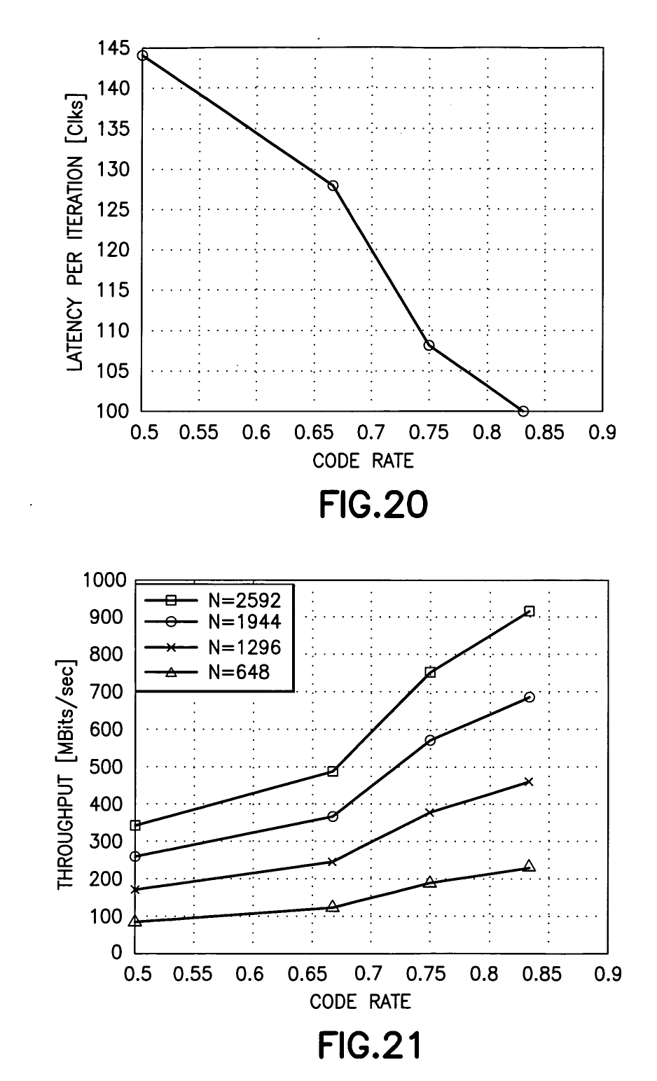

Processing latency P and the number of layers in the PCM determines the latency per iteration. Both quantities depend on the code rate, and the latency per iteration as a function of the code rate is shown in FIG. 20. Because of the full parallelism per layer, this latency doesn't depend on the codeword size or number of rows per layer.

The average decoding throughput that mainly depends on the average number of decoding iterations may be estimated. The average decoding throughput as a function of the code rate for different codeword sizes (e.g., from 648 to 2592) is shown in FIG. 21. The average number of iterations is determined by a frame error rate of 10⁻⁴: typically between 4 and 5.5 while a different SNR is assumed for different codeword sizes and code rates.

The minimum decoding throughput for certain clock frequencies (e.g., in the case of the clock frequency of 200 MHz) depends on the maximum number of decoding iterations. Therefore, it is very important to analyze what lower bound for the maximum number of iterations is acceptable especially if a certain throughput is to be achieved.

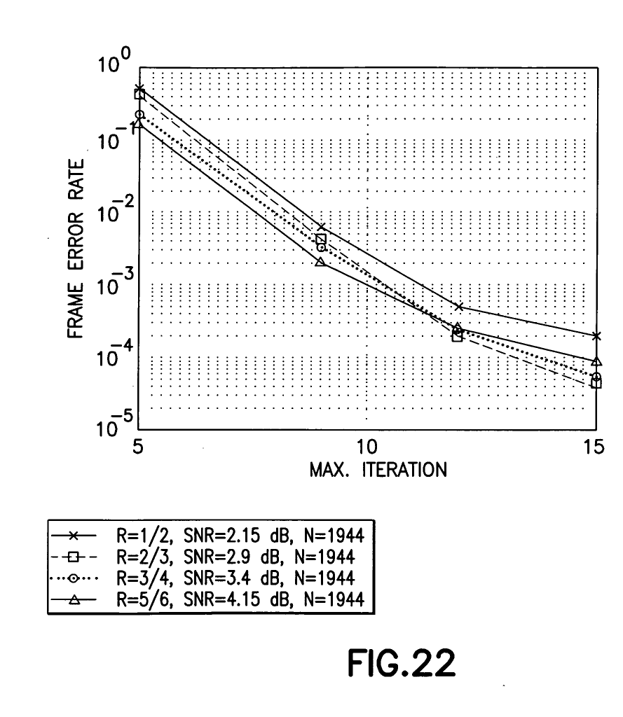

The maximum number of iterations depends on several parameters, including: desirable error-correcting performance (e.g., a frame error rate of 10⁻⁴), and transmission SNR. FIG. 22 shows the FER performance as a function of maximum number of decoding iterations for different code rates (½, ⅔, ¾, and ⅚) for a codeword size of 1944. The values of SNR for different code rates are chosen in order to achieve a FER of about 10⁻⁴ in the case of fifteen decoding iterations. FIG. 22 shows that the performance loss (e.g., when the maximum number of iterations is lower than fifteen) is similar for all code rates: the maximum number of iterations for all supported code rates may be identical. If the desired FER is fixed, the lower bound for the maximum number of iterations depends on what is the maximum acceptable transmission SNR.

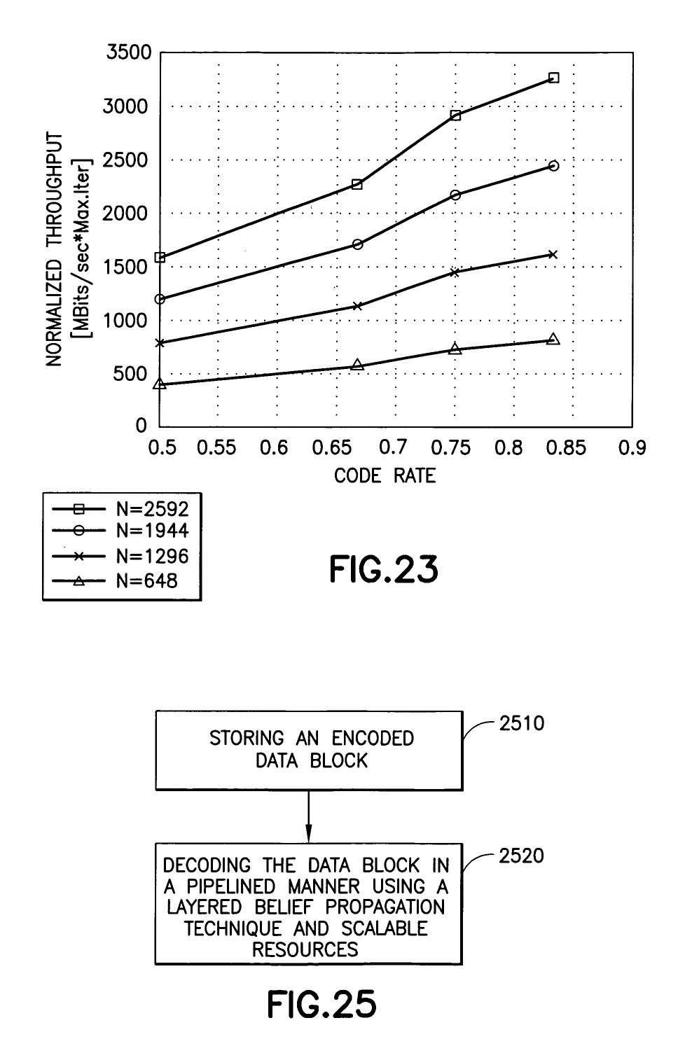

The maximum number of decoding iterations is pre-determined. The maximum achievable throughput, decoding throughput in the case of one decoding iteration, can be estimated. In addition, this “normalized throughput” provides the estimate of the achievable throughput if a certain maximum number of decoding iterations is applied (decoding throughput for different maximum iterations is determined). Maximum achievable throughput for scalable decoder solutions is shown in FIG. 23.

Due to the pipelining of three consecutive layers, there is a possibility for memory conflicts: reading of APP messages from layer l and writing of APP messages for layer l−2 can be from/to the same memory location. This memory conflict may occur when the reading from layer l and the writing to layer l−2 start at the same time. This is due to the fact that almost all non-zero block-columns corresponding to the APP messages are overlapped in the information part of PCMs for all code rates. Such a memory conflict will not happen in embodiments of this invention.

Reading of the layer l starts in the clock cycle is shown by equation (17) in FIG. 2. Writing of layer l−2 starts in the clock cycle (within the particular iteration) is shown by equation (18) in FIG. 2.

The layer l in equations (17) and (18) is the total number of processed layers from the start of the decoding process and not only the layer number within the single decoding iteration.

For rates ⅔, ¾, and ⅚ (since the check node connectivity degree is greater than 8), the inequality shown by equation (19) in FIG. 2 is valid.

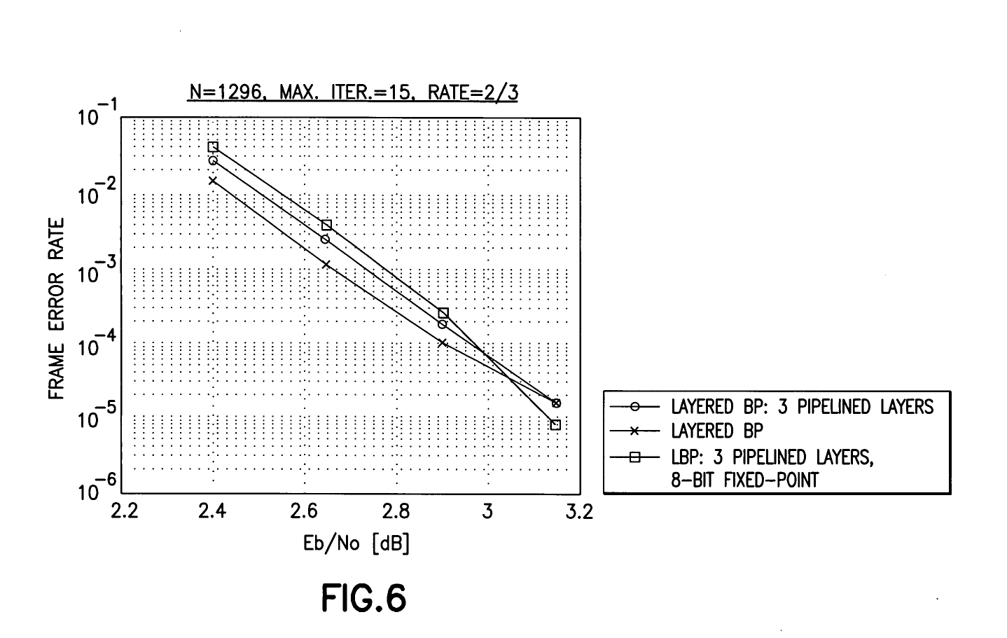

Equation (19) shows that the writing of layer l−2 starts before reading of layer l, which causes no memory conflict. Furthermore, the frame error rate performances are even better (for the case of layer pipelining) than those presented in FIGS. 6-8 since the APP messages are already updated in the layer l−2 before being loaded and utilized in the layer l.

The same equation (19) is valid for code rate of ½ and for codeword sizes of 1296 and 1944 since the check-node connectivity degree is 8 for all layers. For a codeword size of 648, there are two cases (two pair of layers) when reading and writing of two layers begins in the same clock cycle. But, in these two cases, there is no overlapping of block-columns: reading and writing of the blocks of APP messages will be from different memory locations.

A scalable LDPC decoder in accordance with an embodiment of this invention may be based on a layered belief propagation that supports block-structured PCMs for different code rates and different codeword sizes, such as those defined for the IEEE 802.11n standard. The decoder design may be structured—memory modules, banks of DFUs 1410A-C and parts of permuters can be turned off/on depending on the codeword size that is being processed. Implemented scalability (support for variable code rates and codeword sizes) does not increase the number of standard ASIC gates.

Such a decoder may achieve high decoding throughput due to the pipelining of three consecutive layers of a PCM. The average decoding throughput may be up to 700 Mbits/sec. It may be based on the average number of iterations to achieve a frame error rate of 10⁻⁴ and depends on the code rate and codeword size. In the worst case the achievable throughput (throughput determined by the maximum number of iterations) may depends on desired FER, acceptable SNR, code rate, codeword size.

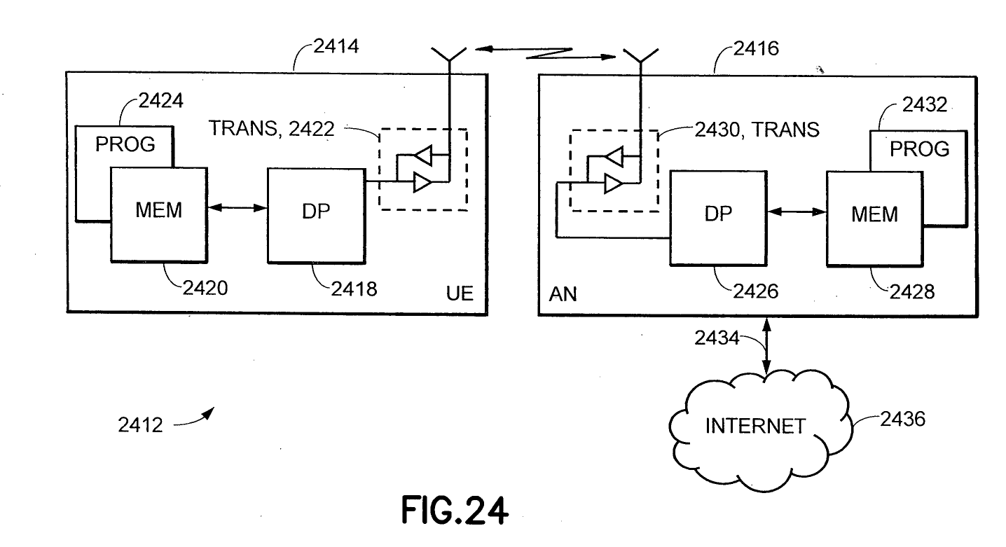

Reference is made to FIG. 24 for illustrating a simplified block diagram of various electronic devices that are suitable for use in practicing the exemplary embodiments of this invention. In FIG. 24, a wireless network 2412 is adapted for communication with a user equipment (UE) 2414 via an access node (AN) 2416. The UE 2414 includes a data processor (DP) 2418, a memory (MEM) 2420 coupled to the DP 2418, and a suitable RF transceiver (TRANS) 2422 (having a transmitter (TX) and a receiver (RX)) coupled to the DP 2418. The MEM 2420 stores a program (PROG) 2424. The TRANS 2422 is for bidirectional wireless communications with the AN 2416. Note that the TRANS 2422 has at least one antenna to facilitate communication.

The AN 2416 includes a DP 2426, a MEM 2428 coupled to the DP 2426, and a suitable RF TRANS 2430 (having a TX and a RX) coupled to the DP 2426. The MEM 2428 stores a PROG 2432. The TRANS 2430 is for bidirectional wireless communications with the UE 2414. Note that the TRANS 2430 has at least one antenna to facilitate communication. The AN 2416 is coupled via a data path 2434 to one or more external networks or systems, such as the internet 2436, for example.

At least one of the PROGs 2424, 2432 is assumed to include program instructions that, when executed by the associated DP, enable the electronic device to operate in accordance with the exemplary embodiments of this invention, as discussed herein.

In general, the various embodiments of the UE 2414 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 2418, 2426 of the UE 2414 and the AN 2416, or by hardware, or by a combination of software and hardware.

The MEMs 2420, 2428 may be of any type suitable to the local technical environment and may be implemented using any suitable data storage technology, such as semiconductor based memory devices, magnetic memory devices and systems, optical memory devices and systems, fixed memory and removable memory, as non-limiting examples. The DPs 2418, 2426 may be of any type suitable to the local technical environment, and may include one or more of general purpose computers, special purpose computers, microprocessors, digital signal processors (DSPs) and processors based on a multi core processor architecture, as non limiting examples.

FIG. 25 shows a method in accordance with an exemplary embodiment of this invention. In step 2510, an encoded data block comprising codewords is stored. In step 2520, the encoded data block is decoded. The LBP decoding occurs in a pipelined fashion and uses scalable resources. These scalable resources (e.g., permuters, memory, and decoding function units) are configurable in order to accommodate any one of at least two possible codeword lengths and any one of at least two possible code rates.

Additionally, the decoding may be performed using a layer belief propagation over the pipelined layers. The pipelining may be performed in such a way so that at least a read operation on one layer is simultaneously performed with a write operation on a preceding layer.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

1. A method comprising:
storing an encoded data block comprising codewords; and
decoding the data block in a pipelined manner using a layered belief propagation technique and scalable resources,
where the scalable resources comprise a scalable permuter, a scalable memory unit, and a scalable decoder, and
where the scalable resources are configurable to accommodate at least two codeword lengths and at least two code rates.

2. (canceled)

3. The method of claim 1, where the scalable permuter comprises a permuter with multiple blocks which are configured to be turned on and off based upon the length of the codeword to be decoded;
where the scalable memory unit comprises a plurality of memory unit banks configured to be turned on and off based upon the length of the codeword to be decoded; and
where the scalable decoder comprises a plurality of decoding function unit banks configured to be turned on and off based upon the length of the codeword to be decoded.

4. The method of claim 1, where the codeword lengths comprise 648, 1296 and 1944.

5. The method of claim 1, where the code rates comprise ½, ⅔, ¾ and ⅚.

6. The method of claim 1, where a pipeline comprises at least three layers and where at least a read operation on one layer is simultaneously performed with a write operation on another layer.

7. The method of claim 1, where data throughput is at least 600 Mbits/sec.

8. The method of claim 1, where the scalable permuter uses memory modules to store the location of non-zero sub-block matrices and shift value/relative offsets to accommodate the at least two code rates.

9. The method of claim 8, where the memory modules are read only memory.

10. The method of claim 1, where the scalable memory unit comprises a first memory bank storing messages, further comprising mirroring the stored messages in a second memory bank.

11. A computer readable medium tangibly embodied with a program of machine-readable instructions executable by a digital processing apparatus to perform operations comprising:
storing an encoded data block comprising codewords; and
decoding the data block in a pipelined manner using a layered belief propagation technique and scalable resources,
where the scalable resources comprise a scalable permuter, a scalable memory unit, and a scalable decoder, and
where the scalable resources are configurable to accommodate at least two codeword lengths and at least two code rates.

12. (canceled)

13. The medium of claim 11, where the scalable permuter comprises multiple blocks which are configured to be turned on and off based upon the length of the codeword to be decoded;
where the scalable memory unit comprises a plurality of memory unit banks configured to be turned on and off based upon the length of the codeword to be decoded; and
where the scalable decoder comprises a plurality of decoding function unit banks configured to be turned on and off based upon the length of the codeword to be decoded.

14. The medium of claim 11, where a pipeline comprises at least three layers and where at least a read operation on one layer is simultaneously performed with a write operation on another layer.

15. The medium of claim 11, where the scalable permuter uses memory modules to store the location of non-zero sub-block matrices and shift value/relative offsets to accommodate the at least two code rates.

16. The medium of claim 11, where the scalable memory unit comprises a first memory bank storing messages, and further comprising mirroring the stored messages in a second memory bank.

17. An apparatus comprising:
a memory configured to store an encoded data block comprising codewords; and
a decoder configured to decode the data block in a pipelined manner using a layered belief propagation technique, further comprising
scalable resources configurable to accommodate at least two codeword lengths and at least two code rates, where the scalable resources comprise a scalable permuter, a scalable memory unit, and a scalable decoder.

18. (canceled)

19. The apparatus of claim 17, where
the scalable permuter comprises multiple blocks which are configured to be turned on and off based upon the length of the codeword to be decoded;
where the scalable memory unit comprises a plurality of memory unit banks configured to be turned on and off based upon the length of the codeword to be decoded; and
where the scalable decoder comprises a plurality of decoding function unit banks configured to be turned on and off based upon the length of the codeword to be decoded.

20. The apparatus of claim 17, where the codeword lengths comprise 648, 1296 and 1944.

21. The apparatus of claim 17, where the code rates comprise ½, ⅔, ¾ and ⅚.

22. The apparatus of claim 17, where a pipeline comprises at least three layers and where at least a read operation on one layer is simultaneously performed with a write operation on another layer.

23. The apparatus of claim 17, where data throughput is at least 600 Mbits/sec.

24. The apparatus of claim 17, where the scalable permuter uses memory modules to store the location of non-zero sub-block matrices and shift value/relative offsets to accommodate the at least two code rates.

25. (canceled)

26. The apparatus of claim 17, where the scalable memory unit comprises a first memory bank storing messages, further comprising mirroring the stored messages in a second memory bank.

27. The apparatus of claim 17, where the apparatus is embodied in at least one integrated circuit.

28. A device comprising:
means for storing an encoded data block comprising codewords;
means for decoding the data block in a pipelined manner using a layered belief propagation technique further comprising;
a scalable resource means which are configurable for accommodating at least two codeword lengths and at least two code rates, and where the scalable resource means comprise a scalable means for permuting, a scalable means for storing data, and a scalable means for decoding.

29. The device of claim 28, where
the scalable permuter means comprises multiple blocks which are configured to be turned on and off based upon the length of the codeword to be decoded;
where the scalable storing means comprises a plurality of memory unit banks configured to be turned on and off based upon the length of the codeword to be decoded; and
where the scalable decoding means comprises a plurality of decoding function unit banks configured to be turned on and off based upon the length of the codeword to be decoded.

32-34. (canceled)
